(19) United States
(12) Patent Application Publication
(10) Pub. No.: US 2006/0103509 A1
(43) Pub. Date: May 18, 2006

(54) Alarm system for a vehicle

(76) Inventor: Eui Yoon Chung, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/281,149

(22) Filed: Nov. 17, 2005

(30) Foreign Application Priority Data
Nov. 17, 2004 (KR) 2004-0094093

(51) Int. Cl. B60Q 1/00

(52) U.S. Cl. 340/425.5

(57) ABSTRACT

Disclosed is an alarm system for a vehicle using optical fibers. The alarm system includes a camera mounted in a portion of the vehicle, for monitoring other vehicles during vehicle operation, an image processing unit installed in the vehicle and connected to the camera, for processing images received from the camera, an electric power source for supplying electricity to the image processing unit and the like, a prism disposed at a portion in front of the camera, optical fibers having a first end connected to the prism and a second end disposed at a portion in each side mirror of the vehicle, lenses which are mounted to the second end of each optical fiber disposed in the respective side mirrors, an alarm device for alerting a driver of the vehicle according to a control signal received from the image processing unit, and a speed sensor for measuring a speed of the vehicle to transmit a value of the speed to the image processing unit. According to the present invention, the alarm system for the vehicle can be mounted in an optimal position to monitor a blind spot of side and rear views. In the alarm system for the vehicle, the optical fibers can be used without damage to the appearance of the vehicle. Further, there is an advantage in that the cost of manufacturing the alarm system can be reduced as only one camera using the optical fibers is employed in the alarm system.

### CROSS-REFERENCE TO RELATED APPLICATION

This application claims priority to and the benefit of Korean Patent Application 10-2004-0094093 filed in the Korean Intellectual Property Office on Nov. 17, 2004, the entire content of which is incorporated herein by reference.

### BACKGROUND OF THE INVENTION

1. Field of the Invention

The present invention relates to an alarm system for an automotive vehicle. More particularly the present invention relates to an alarm system for a vehicle using optical fibers, which can monitor other vehicles approaching a running vehicle from the sides and rear of the running vehicle and provide a warning to the driver.

2. Description of the Prior Art

Generally, an alarm system of an automotive vehicle is a system which has a camera or radar mounted either in both side mirrors or on both sides of the automotive vehicle, so as to monitor approach of other vehicles to the automotive vehicle and provide an alarm for example when the driver attempts to change lanes, when too close to another vehicle. Such an alarm system assists the driver in monitoring through a camera or radar a blind spot other vehicles that the driver cannot see via the side mirrors. Accurate sensors are needed to detect an obstacle. If the alarm system scans too wide a range, the alarm system may detect automotive vehicles in other traffic lanes that are not actually an obstacle.

In a conventional alarm system for monitoring the sides and rear of the vehicle, cameras are generally mounted on both sides of the vehicle in order to monitor obstacles. Thus, two or more expensive camera sensors are required. Alternatively, a single camera can be mounted at the rear portion of the automotive vehicle in order to reduce the number of cameras. In this case, however, the blind spot of the camera becomes larger. Such a camera may fail to detect obstacles existing on the sides of the vehicle. On the other hand, the cameras may be mounted in both side mirrors, respectively. In this case, the side mirrors are required to have too large a size due to the size of the camera sensor. Otherwise, the camera sensor mounted on the side mirror may reduce the effective area of the side mirror, thereby making it difficult for the driver to ensure visibility for the side and rear views of the vehicle.

### SUMMARY OF HE INVENTION

Embodiments of, the present invention provide an alarm system for a vehicle using optical fibers. Visibility is ensured for side and rear views of the vehicle, so as to monitor a blind spot of the side and rear of the vehicle by using a single camera and the optical fibers which is connected to the camera and mounted at optimal positions in side mirrors of the vehicle. There is no necessity for a separate space and wiring process in order to mount a camera in a side mirror.

In an exemplary embodiment, there is provided an alarm system for a vehicle, comprising a camera mounted in a portion of the vehicle for monitoring other vehicles during the vehicle driving; an image processing unit installed in the vehicle and connected to the camera for processing images received from the camera; an electric power source for supplying electricity to the image processing unit and the like; a prism disposed at a portion in front of the camera; optical fibers having a first end connected to the prism and a second end disposed at a portion in each side mirror of the vehicle; lenses which are mounted to the other end of each optical fiber disposed in the respective side mirrors; an alarm device for alerting a driver of the vehicle according to a control signal received from the image processing unit; and a speed sensor for measuring a speed of the vehicle to transmit a value of the speed to the image processing unit.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view showing the structure of an alarm system for an automotive vehicle using optical fibers according to an embodiment of the present invention;

FIG. 2 is a detailed view showing the structure of a alarm system for the automotive vehicle according to an embodiment of the present invention; and

FIG. 3 is a schematic flowchart showing an operation algorithm of an alarm system for a vehicle using the optical fibers according to an embodiment of the present invention.

### DETAILED DESCRIPTION OF THE PREFERRED EMBODIMENTS

Hereinafter, a preferred embodiment of the present invention will be described with reference to the accompanying drawings.

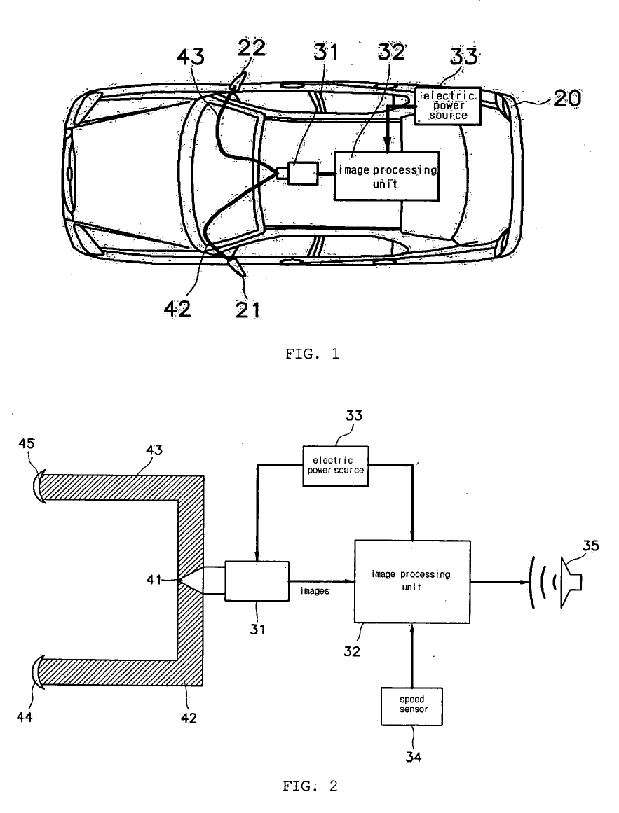

Referring to FIGS. 1 and 2, the alarm system for the automotive vehicle using the optical fibers according to the present invention includes a camera 31, which is mounted in a portion of the vehicle 20, for monitoring other vehicles during the vehicle 20 driving, an image processing unit 32, which is mounted in the vehicle 20 so as to be connected to the camera 31, for processing images received from the camera 31, and an electric power source 33 for supplying electric power to the image processing unit 32. Image processing unit may include a processor and memory, and associated hardware, software and/or firmware as may be selected and programmed by a person of ordinary skill in the art based on the teachings contained herein.

In addition, the alarm system for the vehicle according to an embodiment of the present invention also includes a prism 41 mounted in front of the camera 31. Optical fibers 42 and 43 respectively have a first end connected to the prism 41 and a second end disposed at a portion of each side mirror 21 and 22. Lenses 44 and 45 are respectively mounted on the second end of each optical fiber 42 and 43 disposed in each side mirror 21 and 22. An alarm device alerts the driver of the vehicle 20 according to control signals received from the image processing unit 32, and a speed sensor for measures the speed of the vehicle 20 so as to transmit a value of the speed to the image processing unit 32.

Optical fibers 42 and 43 are also provided for the alarm system for the vehicle 20. A first end of each fiber is connected to one surface of the prism 41 while a second end is disposed in each side mirror 21 and 22 of the vehicle 20. The alarm device includes a speaker 35.

Hereinafter, an operation of the alarm system for the vehicle according to an embodiment of the present invention will be described in detail. A alarm system for the vehicle according to the present invention has lenses 44 and 45 respectively attached to the second end of each optical fiber 42 and 43, which are disposed in side mirrors 21 and 22 of vehicle 20. The alarm system can read images by means of the camera 31 through the lenses 44 and 45 and the prism 41, so as to sense obstacles.

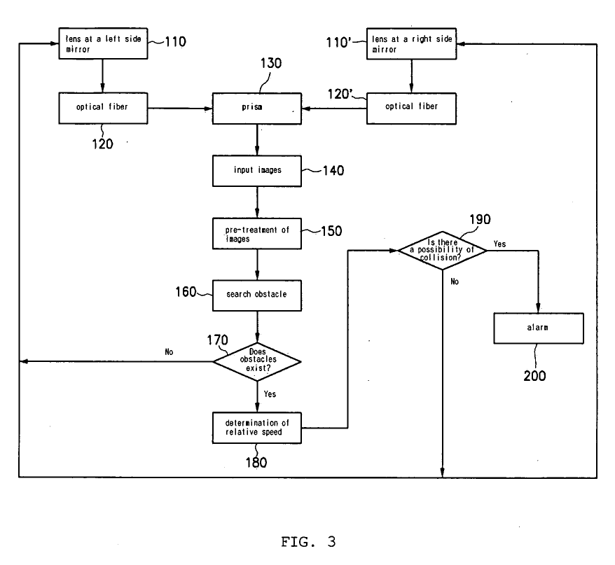

In an alarm system for the vehicle according to an embodiment of the present invention, referring to FIG. 3, the images for the side and rear views of the vehicle 20 are input through the lenses 44 and 45, the optical fibers 42 and 43, the prism 41 and the camera 31 into the image processing unit 32 (steps 110 to 140).

The image processing unit 32 performs a pre-treatment processing on input images and then determines whether or not the obstacles exist at both the sides and rear of the vehicle 20 (steps 150 and 160). As a result of the determination, if obstacles exist, the image processing unit 32 measures a relative speed of the vehicle 20 using information from the speed sensor 34 (steps 170 and 180). After the measurement of the relative speed of the vehicle 20, the image processing unit 32 determines whether or not there is a possibility of collision of the vehicle 20 with other vehicles (steps 190 and 200). Then, if the conditions at steps 170 and 190 are not satisfied, control processes in the flowchart will be repeated from the beginning.

As described above, an alarm system of the present invention detects other vehicles at the rear of the vehicle 20 and alerts to the existence of other vehicles, thereby assisting the driver to safely operate the vehicle 20.

Meanwhile, the optical fibers 42 and 43 can be mounted at an optimal position on both sides of the vehicle 20 in order to monitor the blind spot of the side and rear views of the vehicle 20. Further, the optical fibers 42 and 43 can be installed in the vehicle without damage to the vehicle because the installation of the optical fibers 42 and 43 needs only a hole having a size corresponding to a diameter of the optical fiber.

Furthermore, the alarm system according to the present invention can monitor the vehicles driving beside the vehicle 20 as well as other vehicles. As a result the driver can smoothly control the vehicle 20, thereby contributing to an improvement of a passenger's comfort.

The alarm system for the vehicle uses only one camera 31 having optical fibers 42 and 43. Further, the alarm system for the vehicle does not require a wiring process and a space for receiving the camera 31 in the side mirrors 21 and 22 because optical fibers 42 and 43 smaller than the camera 31 are used. As described above, as it is unnecessary to provide a space in which to dispose the camera 31 in each side mirror 21 and 22, it is possible to increase the size of the side mirrors 21 and 22, thereby preventing the side mirrors from having an effect on wind-noise.

An alarm system for the vehicle using the optical fibers according to an embodiment of the present invention has advantages as follows. The alarm system for the vehicle can be mounted on an optimal position to monitor the blind spot of side and rear views. In the alarm system for the vehicle, the optical fibers can be used without damage of appearance of the vehicle. Further, there is an advantage in that the cost of manufacturing the alarm system can be reduced as only one camera using the optical fibers is employed in the alarm system.

Although exemplary embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. An alarm system for a vehicle, comprising:
a camera mounted in of the vehicle for monitoring other vehicles during operation;
an image processing unit installed in the vehicle and connected to the camera for processing images received from the camera;
an electric power source for supplying electricity to the image processing unit and system;
a prism disposed at a portion in front of the camera;
optical fibers having a first end connected to the prism and a second end disposed at a portion in each side mirror of the vehicle;
lenses which are mounted to the second end of each optical fiber disposed in the respective side mirrors;
an alarm device for alerting a driver of the vehicle according to a control signal received from the image processing unit; and
a speed sensor for measuring a speed of the vehicle to transmit a speed value to the image processing unit.

2. The alarm system for a vehicle as claimed in claim 1, wherein two optical fibers are provided to the alarm system, of which respective first ends are connected to each surface the prism while the second ends are disposed in the side mirrors respectively.

3. The alarm system for a vehicle as claimed in claim 1, wherein the alarm device includes a speaker.

4. An alarm system for a vehicle, comprising:
a camera mounted in for monitoring other vehicles;
an image processing unit communicating with the camera for processing images received from the camera;
an electric power source connected to supply electricity to the image processing unit and system;
a prism disposed in front of the camera;
optical fibers each having a first end connected to the prism and a second end configured to be disposed in a region of the vehicle where visualization is needed;
lenses mounted to the second end of each said optical fiber;
an alarm configured to provide an alert according to a control signal received from the image processing unit; and
a speed sensor for communicating a speed of the vehicle with the image processing unit.

5. The alarm system for a vehicle as claimed in claim 4, wherein two optical fibers are provided with the second ends configured to be disposed in side mirrors of the vehicle.

6. The alarm system for a vehicle as claimed in claim 4, wherein the alarm includes a speaker.

7. The alarm system for vehicles as claimed in claim 4, further comprising an electric power source connected to supply electricity to the image processing unit and system.
